(19) United States
(12) Patent Application Publication
(10) Pub. No.: US 2026/0338286 A1
(43) Pub. Date: Oct. 29, 2026

(54) CHECK VALVE

(71) Applicant: Eugen Seitz AG, Wetzikon (CH)

(72) Inventors: Alexander MÜLLER, Schwerzenbach (CH); Beat SCHMID, Zimikon (CH); Agim GASHI, Bülach (CH)

(73) Assignee: Eugen Seitz AG, Wetzikon (CH)

(21) Appl. No.: 19/107,272

(22) PCT Filed: Aug. 25, 2023
(86) PCT No.: PCT/EP2023/073413

§ 371 Date: Feb. 27, 2025

(30) Foreign Application Priority Data
Aug. 30, 2022 (EP) 22192910.2

(51) Int. Cl. F16K 15/02; F16K 27/02; F17C 13/04

(52) U.S. Cl. CPC F16K 15/026; F16K 27/0209; F17C 13/04; F17C 2205/0335; F17C 2205/0382; F17C 2221/012; F17C 2265/065

(57) ABSTRACT

A check valve of a hydrogen refuelling system has an inlet and an outlet defining a flow direction extending from the inlet to the outlet. The check valve has a piston arranged to be moved relative to the inlet and outlet for opening and closing the inlet, wherein the piston defines a piston axis with a first end facing the inlet and a second end facing the outlet. The piston has an outer surface along which flows a fluid flowing through the check valve in the flow direction.

The outlet has outlet channels allowing the fluid to flow out of the check valve, wherein all of the outlet channels of the outlet run obliquely to the piston axis. The check valve can be used for high pressures and allows gentle closing even with a reversal of the pressure action. It can be used in hydrogen filling stations.

### TECHNICAL FIELD

The present invention relates to a check valve, in particular a check valve of a hydrogen refueling system, and to a unit of a hydrogen refueling system.

### PRIOR ART

A hydrogen refueling system, in particular a hydrogen refueling station, has one or more pressurized tanks, in which liquid or compressed gaseous hydrogen for refueling motor vehicles or rail vehicles is made available. The pressurized tanks are also referred to as banks or storage banks.

In order to fully refuel a vehicle as quickly as possible, the hydrogen is drawn successively from a number of storage banks. The further refueling of the vehicle has progressed, the higher the pressure must be in the storage banks. The pressures in the individual storage banks are therefore different, usually being 350 bar, 500 bar, 700 bar and 1000 bar. Storage banks at other pressures are also possible, however.

To enable the vehicle to be refueled as quickly as possible, it must be possible to switch to storage banks at higher pressures as quickly as possible.

High-pressure valves, in particular pilot-controlled solenoid valves, allow quick switching times and thus also rapid storage bank changeovers. The switching times are between 10 ms and 200 ms. Check valves prevent return flow of the hydrogen from a dispensing line connected to the vehicle tank to the storage bank.

The rapid opening of the storage banks leads to high pressure surges or pressure pulses in the storage bank line. These high pressure surges can damage the check valve, downstream in the flow direction, of the storage bank. In particular, the sealing element may be displaced in the flow direction, with the result that the check valve no longer closes.

If a change is made to a higher pressure level and thus to a different storage bank during refueling, the check valve also suffers high pressure surges or pressure pulses in the counterflow direction. These pressure surges are caused by the increase in pressure in the line. Solenoid valves generally close more slowly than they open. This has the effect that the check valve of a first or upstream storage bank has not yet fully closed when a solenoid valve of a second or successive storage bank is already fully open. The pressure surge acting on the check valve closes the check valve with a relatively large force. Its piston is often pressed with a large force into the sealing seat. On the one hand, this reduces the life of the check valve massively. The sealing seat may even be damaged, such that the check valve no longer closes in an optimum manner. This limits the maximum pressure that can actually be present in a storage bank.

These high pressure surges in the flow direction, but also in particular in the counterflow direction, therefore impose severe demands on the check valves and reduce their life. This gives rise to high maintenance costs and can lead to refueling system failures.

The prior art includes check valves in which a steel piston through which a fluid flows strikes an elastomeric or thermoplastic sealing element. There are also known steel pistons on which an elastomeric or thermoplastic sealing element is arranged. At high pressures, such as those used in hydrogen refueling stations, there is the risk that the sealing element will fly out or at least be displaced.

Check valves with a steel piston through which the fluid flows and which strike a steel seat have the disadvantage that they provide a poorer seal than soft seats with an elastomeric or thermoplastic sealing element.

DE 10 2016 014 312 A1 discloses a check valve having a piston made of PEEK (polyetheretherketone), which is penetrated by oblique channels. It is used especially in piston pumps and compressors.

The prior art also includes check valves in which the fluid flows around the valve piston. However, these are not secured against reverse surges and are therefore not suitable for pressures of the kind that occur in hydrogen refueling systems.

### DESCRIPTION OF THE INVENTION

It is therefore an object of the invention to provide a check valve, in particular for hydrogen refueling systems, which exhibits gentle closing behavior, even when subjected to pressure in the opposite direction, and which has a life that is as long as possible, even when subjected to high pressure surges.

This object is achieved by a check valve having the features of patent claim 1 and by a unit of a hydrogen refueling system having the features of patent claim 19.

The check valve according to the invention has an inlet and an outlet, which define a flow direction that extends from the inlet to the outlet. The check valve has a piston, which is arranged such that it can move relative to the inlet and outlet, for opening and closing the inlet of the check valve. The piston defines a piston axis with a first end facing the inlet and a second end facing the outlet. The piston has an outer surface, along which a fluid flowing through the check valve in the flow direction flows. The outlet has outlet channels to allow the fluid to flow outward out of the check valve, wherein all of the outlet channels of the outlet run obliquely, i.e. at an angle not equal to 0°, with respect to the piston axis.

By virtue of the outlet channels running obliquely to the piston axis, it is not possible for a fluid flowing at high pressure into the check valve from the outlet side to exert a high pressure pulse on the piston. Thus, if a fluid flows in in the counterflow direction, i.e. from the outlet side, the check valve nevertheless closes relatively gently.

When the piston is subjected to a fluid in the flow direction, there is a flow around the piston. The fluid flows along the outer surface of the piston. Pressure pulses acting on the piston can thereby be minimized, and pressure losses can be reduced. A high flow rate through the check valve is made possible.

The check valve is suitable for various applications, especially for applications involving high pressure pulses in the counterflow direction. The check valve is suitable especially for use in a hydrogen refueling system, in particular in a hydrogen refueling station for motor vehicles. In particular, the check valve can be used at pressures of up to 1000 bar and above. Thanks to the increased life of the check valve, maintenance intervals and maintenance costs of a system, in particular a hydrogen refueling system, are reduced. Failures of such systems are reduced or avoided. Other areas of application are, for example, hydrogen tankers and electrolyzers for the production of hydrogen.

The check valve according to the invention is furthermore suitable for retrofitting to systems since it is of relatively space-saving and simple construction.

Preferably all the flow flows around the piston, that is to say none of the fluid flows through the piston. In an open position of the piston, preferably only one channel is open, which extends from the inlet to the outlet and which extends exclusively along the outer surface of the piston. Preferably, the piston opens only one channel between the inlet and outlet, which extends along the outer surface of the piston. This optimizes the damping of the piston during the opening and closing of the valve and allows a high flow rate in the flow direction from the inlet to the outlet. Moreover, the piston can be embodied in a robust and thus long-life manner since it is not penetrated by any channels, which might weaken it.

The piston is preferably movable in a guided manner. In a preferred embodiment, the piston has radially projecting ribs on its circumference, wherein the outer surface along which the fluid flows is preferably arranged between the ribs. These ribs minimize vortices in the fluid flow. They preferably guide the piston in its movement. In some embodiments, at least one of the ribs is supported in the valve body.

The check valve preferably has a valve body in which the piston is movably arranged, wherein the piston is movable with guidance by the valve body. If there are ribs on the piston, they preferably extend as far as the inner wall of the valve body in order to guide the piston and direct the fluid. Depending on the embodiment, at least one of the ribs, preferably all the ribs, are supported in the valve body.

There is preferably the same number of outlet channels as surfaces between the ribs. This optimizes the fluid flow along the piston.

The valve body preferably has a sealing seat, on which the piston rests in the closed state of the check valve, wherein the sealing seat is preferably made of metal. There is preferably no elastomeric seal, e.g. an O-ring, either on the sealing seat or on the piston. The piston preferably seals without an elastomeric seal.

In one preferred embodiment, at least one part of the piston is manufactured from a plastic, in particular from a high-performance plastic, and preferably from PEEK. Preferably, the entire piston is manufactured from plastic, in particular from a high-performance plastic, and preferably from PEEK. This enhances the damping properties of the piston. In addition, the piston has a relatively low weight. The moving mass of the check valve is reduced. The opening and closing speed and impact resistance are increased. There is no need for an additional elastomeric sealing element between the piston and the sealing seat.

If the sealing seat is manufactured from metal and a piston made of plastic, in particular of PEEK, is used, the sealing effect is optimized. High-performance plastics, in particular PEEK, are durable in a very wide temperature range, which may be either in the negative or in the positive °C range. This makes the check valve ideally suited to long-term use for hydrogen.

There is preferably a coupling element, which is secured on a housing of the check valve, wherein the coupling element has through openings, which form the outlet channels. It is thereby possible to maximize the throughflow in the flow direction out of the check valve through the outlet channels. This is optimum, in particular, for hydrogen refueling systems since the refueling time can be minimized. Pressure losses are minimized thanks to outlet channels with large diameters. The piston is preferably guided in the valve body and is arranged at a distance from the coupling element.

The coupling element can be designed, for example, as a hollow screw, which can be screwed into the housing or onto the housing. This facilitates assembly.

The valve body preferably forms the housing of the check valve.

There is preferably a return spring, which presses the piston into a sealing seat in order to close the check valve. The return spring is preferably arranged with a first end in the piston and with a second end in the coupling element. The return spring is preferably arranged in the piston, wherein it is surrounded by the outlet channels. This is an extremely compact arrangement, and therefore the size of the check valve is minimized.

The unit according to the invention of a hydrogen refueling system has a first line for connecting a first storage bank to a dispensing line and has a second line for connecting a second storage bank to the same dispensing line. A fueling direction leads from the first storage bank and the second storage bank to the dispensing line. A first high-pressure valve, in particular a pilot-valve-controlled solenoid valve, and a first check valve are arranged in the first line, wherein the first check valve is arranged after the first high-pressure valve in the fueling direction. A second high-pressure valve, in particular a pilot-valve-controlled solenoid valve, and a second check valve are arranged in the second line, wherein the second check valve is arranged after the second high-pressure valve in the fueling direction. The first check valve and the second check valve are check valves of the kind described above. The fueling direction is preferably the abovementioned flow direction through the check valve.

Further embodiments are given in the dependent claims.

### BRIEF DESCRIPTION OF THE DRAWINGS

A preferred embodiment of the invention is described below by means of the drawings, which serve merely for explanation and should not be interpreted as restrictive. In the drawings:

FIG. 1 shows a schematic illustration of a unit of a hydrogen refueling system;

FIG. 2 shows a perspective illustration of a check valve according to the invention having an inlet and an outlet line;

FIG. 3 shows a longitudinal section through the check valve according to FIG. 2 in the closed state;

FIG. 4 shows another longitudinal section through the check valve according to FIG. 2 in the closed state;

FIG. 5 shows a longitudinal section through the check valve according to FIG. 2 in the open state;

FIG. 6 shows a first perspective illustration of a piston of the check valve according to FIG. 2;

FIG. 7 shows a first view of an end face of the piston according to FIG. 6;

FIG. 8 shows a second perspective illustration of the piston according to FIG. 6;

FIG. 9 shows a second view of an end face of the piston according to FIG. 6;

FIG. 10 shows a side view of the piston according to FIG. 6;

FIG. 11 shows a first perspective illustration of a coupling element of the check valve according to FIG. 2;

FIG. 12 shows a first view of an end face of the coupling element according to FIG. 11;

FIG. 13 shows a second perspective illustration of the coupling element according to FIG. 11;

FIG. 14 shows a second view of an end face of the coupling element according to FIG. 11; and

FIG. 15 shows a side view of the coupling element according to FIG. 11.

### DESCRIPTION OF PREFERRED EMBODIMENTS

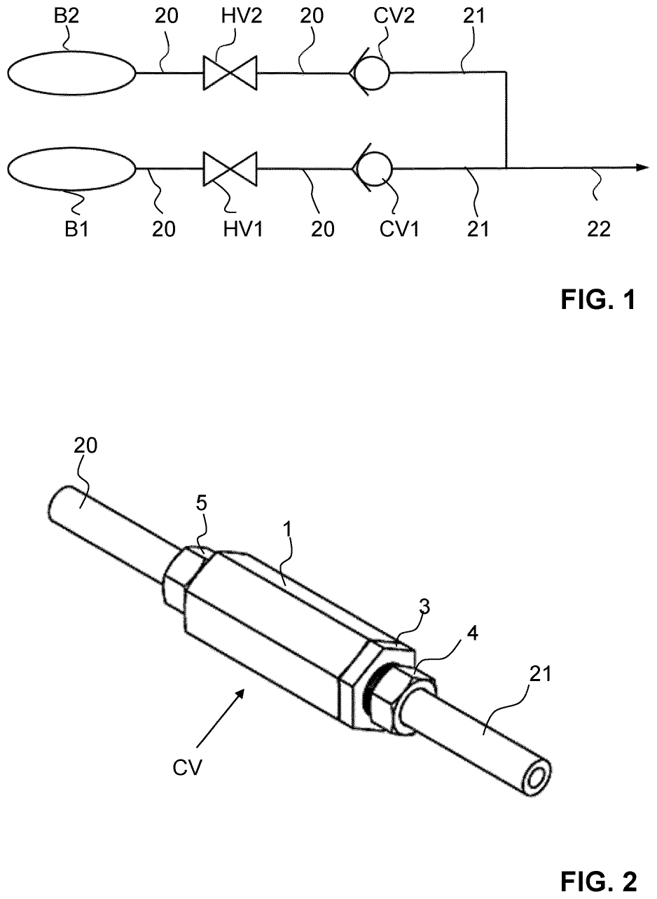

FIG. 1 provides a schematic illustration of a refueling station comprising two storage banks B1, B2 for hydrogen. There are usually three, four or more storage banks B1, B2 per refueling point.

The individual hydrogen storage banks B1, B2 are at different pressures. The pressures are preferably 350 bar, 500 bar, 700 bar and 1000 bar. In this example, the first storage bank B1 is at a lower pressure than the second storage bank B2.

A respective feed line 20 leads from each storage bank B1, B2, via valves HV1, HV2, CV1, CV2, to an intermediate line 21 and then to a common dispensing line 22, which leads to a refueling point (not illustrated). This is the fueling direction when refueling a motor vehicle (likewise not illustrated) and the flow direction through the valves HV1, HV2, CV1, CV2. The feed line 20, the intermediate line 21 and the dispensing line 22 are preferably metal pipes. There are preferably rigid.

FIG. 1 does not show a cryogenic pump connected to the storage banks B1, B2 or a compressor for compressing the hydrogen, nor the refueling points, also referred to as fuel pumps, which are connected to the storage banks B1, B2 via the dispensing line 22 and at which the motor vehicles can be refueled with hydrogen.

Each storage bank B1, B2 is assigned a high-pressure valve HV1, HV2, preferably a pilot-controlled solenoid valve. Downstream of the high-pressure valve HV1, HV2 in the flow direction there is in each case an associated check valve CV1, CV2. When subjected to pressure in the flow direction, the check valve CV1, CV2 opens toward the dispensing line 22 and prevents fluid flow in the opposite direction, i.e. it prevents a return flow in the direction of the storage banks B1, B2.

During the refueling of a motor vehicle, hydrogen is taken first from the storage bank at the lowest pressure, in this example therefore from the first storage bank B1. For this purpose, the associated first high-pressure valve HV1 is opened, as a result of which the associated first check valve CV1 also opens on account of the pressure of the fluid flow, in this case hydrogen, said pressure acting in the flow direction. The second solenoid valve HV2 and thus also the second check valve CV2 are closed. The fluid, in this case hydrogen, flows from the first storage bank B1, via the feed line 20 and the intermediate line 21, to the dispensing line 22 and thus to the refueling point.

When the pressure in the tank of the motor vehicle rises, the pressure difference between the first storage bank B1 and the tank decreases. In order to enable continued rapid refueling, there is a changeover to the second storage bank B2, which is at a higher pressure. The first high-pressure valve HV1 is therefore closed, and the second high-pressure valve HV2 and thus also the second check valve CV2 are opened. Since the first solenoid valve HV1 and/or the first check valve CV1 close/closes more slowly than the other valves open, the now increased pressure in the intermediate line 21 acts on the not yet fully closed first check valve CV1. This pressure surge accelerates the closing element of the check valve CV1, usually a piston, causing it to bang into the sealing seat at high speed. As mentioned at the outset, this can damage the check valve or at least massively shorten its life.

FIGS. 2 to 5 illustrate an example of a check valve CV according to the invention, which can be employed in the arrangement shown in FIG. 1 as a first and second check valve CV1, CV2. However, it can also be employed in other areas in which good damping of the piston movement or a gentle piston movement, at least in the flow direction and/or in the counterflow direction, is advantageous. The valve can also be used for other fluids and in other systems.

The check valve CV has a valve body 1, which forms a housing of the check valve CV. The valve body 1 is preferably of one-piece design. It is preferably made of metal, in particular steel.

It has an interior in which a piston 6 is arranged in such a way as to be movable in the longitudinal direction of the valve body 1. A coupling element 3 is held on or in the valve body 1. In this example, the coupling element 3 is designed as a hollow screw and is screwed by means of an external thread 31 onto an end of the valve body 1 on the outlet side in the flow direction. The coupling element 3 has a main body 30 and a flange 32, wherein the flange 32 preferably rests on the outer end face of the valve body 1. The coupling element 3 has an internal thread 320, preferably in the region of the flange 32. An encircling beveled edge 321, which forms a cone that tapers in the counterflow direction, is preferably formed in the interior of the coupling element 3.

The intermediate line 21 forms an outlet line of the check valve CV. It is connected to the valve body 1 via a first connecting element 4 with an external thread 40 and a first bush 80 with an internal thread 81. In this example, it is connected for this purpose to the coupling element 3. The intermediate line 21 preferably rests against the encircling beveled edge 321 and is thus, on the one hand, secured against rotation and held fixed in the longitudinal direction.

As already mentioned, the intermediate line 21 leads to the refueling point. It is therefore arranged on the outlet side of the check valve CV.

At the opposite end of the valve body 1, the feed line 20 is connected by means of a second connecting element 5 with an external thread 50 to the valve body and by means of a second bush 82 with an internal thread 83 to the valve body 1. The feed line 20 forms an inlet line of the check valve CV. In the interior, the valve body 1 likewise has an encircling beveled edge 10, which forms a cone that now tapers in the flow direction. The feed line 20 rests against this beveled edge 10 and is thus secured against rotation and held fixed in the longitudinal direction.

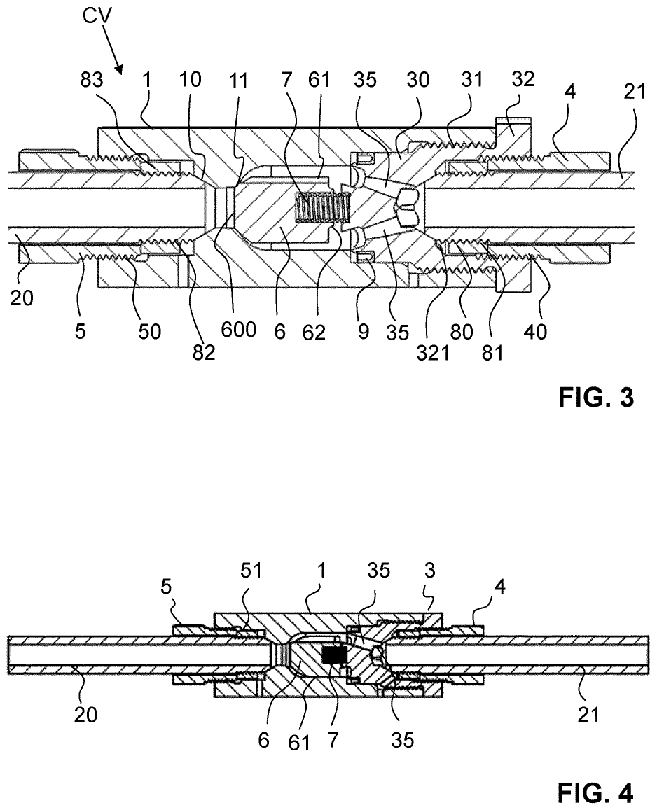

As is readily apparent from FIGS. 3 to 6, a return spring 7 is arranged between the piston 6 and the coupling element 3. It is inserted with one end into a receiving opening 620 of the piston 6 and with another end into a receiving opening 36 of the coupling element 3, and held therein. It extends centrally and in the direction of the piston axis 63, which is visible in FIG. 10.

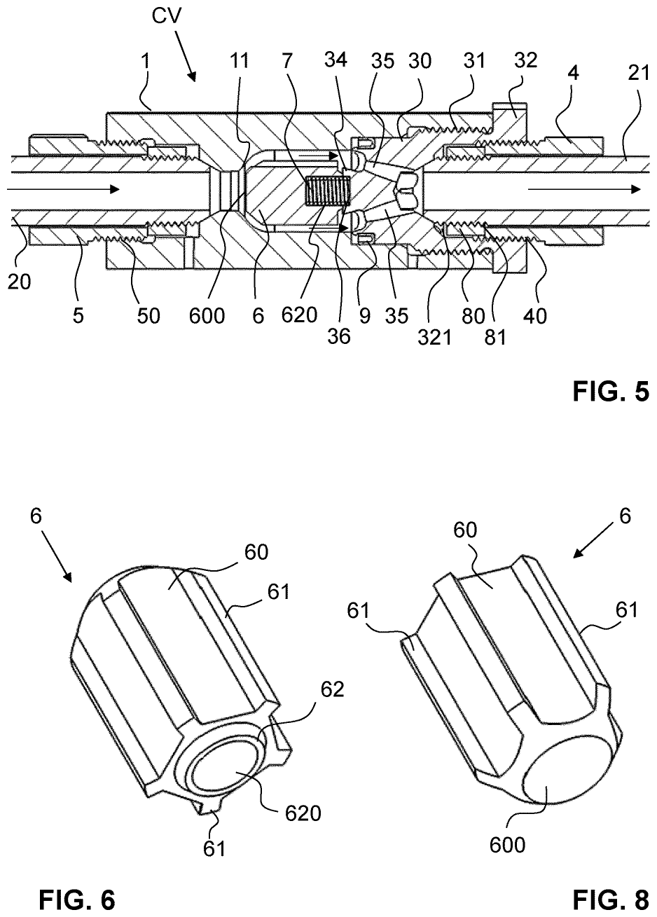

In FIG. 3, the check valve CV is illustrated in the closed state, while, in FIG. 5, it is illustrated in the open state. The flow direction through the opened valve is illustrated in FIG. 5 by arrows. A fluid flowing through, preferably hydrogen, flows around the outer surface of the piston 6 and flows between the piston 6 and the inner wall of the valve body 1 through outlet channels 35 of the coupling element 3. As is readily apparent in FIGS. 3 and 5, the outlet channels 35 run obliquely, i.e. at an angle, to the piston axis 63. The outlet channels 35 open in a common chamber 38, which is connected to the lumen of the intermediate line 21, thus enabling the fluid to flow out of the check valve CV.

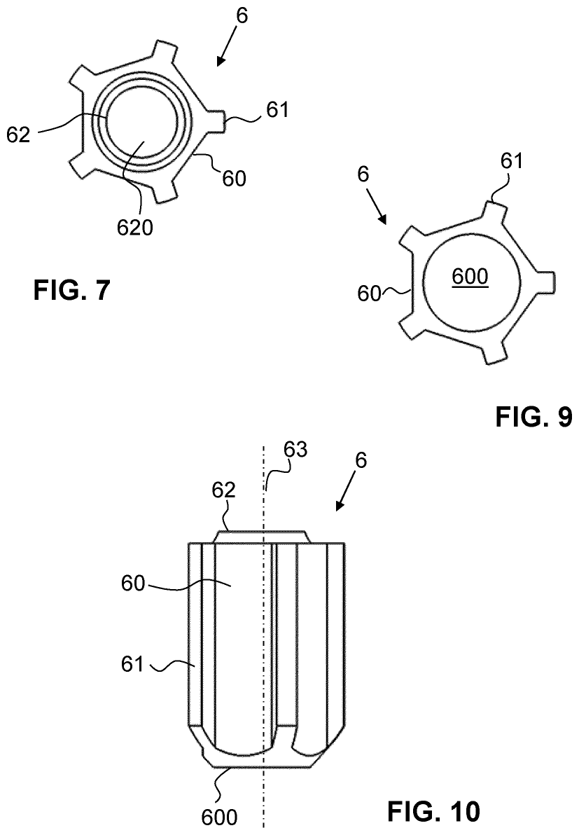

The piston 6 is illustrated in detail in FIGS. 6 to 10. It is preferably produced from a high-performance plastic and, even more preferably from PEEK. The piston 6 forms a seal in the sealing seat 11 of the valve body 1 without a sealing ring or additional seal. The sealing seat 11 is preferably produced from steel or some other metal. Alternatively, it is produced from some other material that is harder than the material of the piston 6.

The piston 6 has a main body 60 with a first and a second end. The first end has an end piece 62 with a receiving opening 620 in the form of a blind hole. In this example, the end piece 62 is frustoconical, and the receiving opening 620 is circular. Other shapes are possible. The receiving opening 620 serves to receive the return spring 7, as is readily apparent in FIGS. 3 and 5. The opposite end face 600 is closed and is preferably of flat design. This end is of conical design and tapers toward the free end face 600. This end face 600 and/or the conical region adjacent thereto form/forms the sealing region for closing the check valve CV. When the valve is closed, the piston 6 rests by means of this sealing region against the widening sealing seat 11. This is readily apparent in FIGS. 3 and 4.

Radial ribs 61 project from the main body 60. They extend parallel to the piston axis 63. They preferably extend approximately over the entire length of the main body. In this example, there are five ribs 61, matching the five outlet channels 35 of the coupling element 3. Between the ribs, the main body 60 forms the outer surfaces along which the fluid flows. The number of surfaces in between is thus preferably the same as the number of outlet channels 35. The outlet channels 35 are preferably in alignment with the surfaces situated between the ribs 61.

A different number of ribs 61 and outlet channels 35 is likewise possible. There may also be a different number of ribs 61 in comparison with the outlet channels 35.

The ribs 61 preferably extend as far as the inner wall of the valve body 1. The piston 6 can thus move within the valve body 1 in a manner guided along the piston axis 60. Depending on the embodiment, the piston 6 is arranged in the valve body 1 in such a way as to be rotatable about its piston axis. In other embodiments, it is arranged in a manner secured against rotation in the valve body 1. In one embodiment, the piston 6 is supported in the valve body 1 by at least one rib 61.

Owing to the sections chosen, there is a clearance between the ribs 61 of the piston 6 and the valve body 1 in each of FIGS. 3 to 5. In the section according to FIG. 4, however, it can be seen in the lower region of the piston 6 that it rests against the inner wall of the valve body 1.

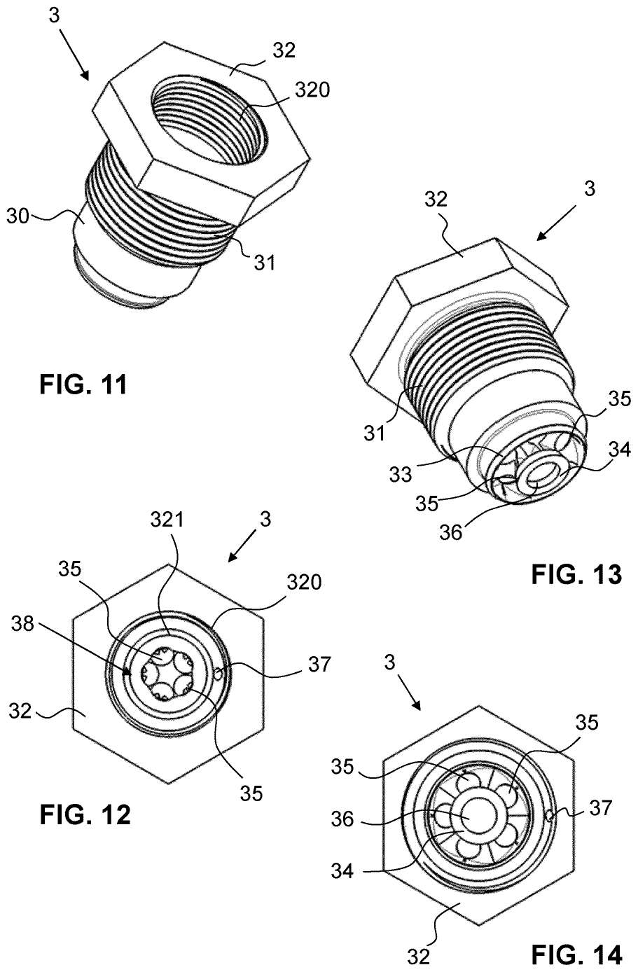

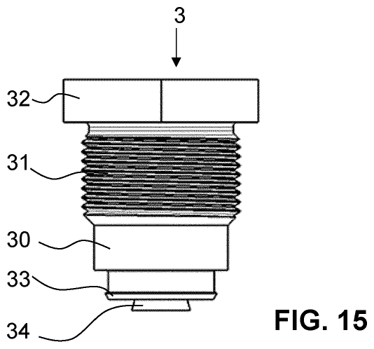

The coupling element 3 is illustrated in detail in FIGS. 11 to 15. It is preferably manufactured from metal or from a high-performance plastic. It has a cylindrical main body 30, which at one end has the external thread 31 and the adjoining flange 32. The internal thread 320 is arranged in the flange 32. At the opposite end, the main body 30 preferably has a region 33 which tapers in the form of a step and which is followed by an end piece 34 of smaller diameter. The outlet channels 35 are arranged in the main body 30 and/or in the tapered region, as is readily apparent from a joint examination of FIGS. 14 and 3. A sealing ring 9 seals the coupling element 3 with respect to the valve body 1 in the tapered region 33, as can be seen in FIG. 3. This sealing ring 9 is preferably the only sealing ring, and it is situated between two static components. In FIGS. 12 and 14 there is a vent opening 37. It leads through the valve body 1 to the outside and enables the sealing points to be checked, for example.

When a fluid flows in the flow direction, i.e. from left to right in FIGS. 3 and 5, through the feed line 20 into the check valve CV, the piston 6 is pushed to the right against the force of the return spring 7, and the valve opens. The fluid flows along the outer surface of the piston 6 to the outlet channels 35 and into the intermediate line 21. If the fluid pressure in this direction ceases, the check valve CV closes automatically by virtue of the return spring 7.

If, however, a fluid pressure in the opposite direction to the flow direction is exerted on the valve even before closure, that is to say if a fluid flows from right to left through the outlet channels 35 into the interior of the valve body 1, the pressure surge on the piston 6 is reduced thanks to the oblique arrangement of the outlet channels 35. This is because the application of pressure takes place only to a minimal extent, if at all, in a direction perpendicular to the piston. The piston 6 can therefore not strike the sealing seat with a large force. As before, the closing movement of the piston is gentle or damped.

The check valve according to the invention can be employed for high pressures and allows gentle closing, even when the action of the pressure is reversed.

LIST OF REFERENCE SIGNS

| | |
|---|---|
| 1 | valve body |
| 10 | beveled edge |
| 11 | sealing seat |
| 20 | feed line |
| 21 | intermediate line |
| 22 | dispensing line |
| 3 | coupling element |
| 30 | main body |
| 31 | external thread |
| 32 | flange |
| 320 | internal thread |
| 321 | beveled edge |
| 33 | tapered region |
| 34 | end piece |
| 35 | outlet channel |
| 36 | receiving opening |
| 37 | vent opening |
| 38 | chamber |
| 4 | first connecting element |
| 40 | external thread |
| 5 | second connecting element |
| 50 | external thread |
| 6 | piston |
| 60 | main body |
| 600 | end face |
| 61 | rib |
| 62 | end piece |
| 620 | receiving opening |
| 63 | piston axis |
| 7 | return spring |
| 80 | first bush |
| 81 | internal thread |
| 82 | second bush |
| 83 | internal thread |
| 9 | sealing ring |
| B1 | first storage bank |
| B2 | second storage bank |
| HV1 | first high-pressure valve |
| HV2 | second high-pressure valve |
| CV1 | first check valve |
| CV2 | second check valve |
| CV | check valve |

1. A check valve,
wherein the check valve has an inlet and an outlet, which define a flow direction that extends from the inlet to the outlet,
and wherein the check valve has a piston, which is arranged such that it can move relative to the inlet and outlet, for opening and closing the inlet of the check valve,
wherein the piston defines a piston axis with a first end facing the inlet and a second end facing the outlet,
wherein the piston has an outer surface, along which a fluid flowing through the check valve in the flow direction flows, and
wherein the outlet has outlet channels to allow the fluid to flow outward out of the check valve,
wherein all of the outlet channels of the outlet run obliquely with respect to the piston axis.

2. The check valve as claimed in claim 1, wherein, in an open position of the piston, only one channel is open, which extends from the inlet to the outlet and which extends exclusively along the outer surface of the piston.

3. The check valve as claimed in claim 1, wherein the piston opens only one channel between the inlet and outlet, which extends only along the outer surface of the piston.

4. The check valve as claimed in claim 1, wherein the piston has radially projecting ribs on its circumference.

5. The check valve as claimed in claim 5, wherein the check valve has a valve body, wherein the piston is arranged movably in the valve body and wherein the piston is movable with guidance by the valve body.

6. The check valve as claimed in claim 5, wherein the piston has radially projecting ribs on its circumference and wherein at least one of the ribs is supported in the valve body.

7. The check valve as claimed in claim 5, wherein the valve body has a sealing seat, on which the piston rests in the closed state of the check valve, and wherein the sealing seat is made of metal.

8. The check valve as claimed in claim 4, wherein the outer surface along which the fluid flows is arranged between the ribs

9. The check valve as claimed in claim 1, wherein the piston seals without an elastomeric seal.

10. The check valve as claimed in claim 1, wherein at least one part of the piston is manufactured from a plastic.

11. The check valve as claimed in claim 10, wherein the entire piston is manufactured from plastic.

12. The check valve as claimed in claim 1, wherein there is a return spring which presses the piston into a sealing seat in order to close the check valve.

13. The check valve as claimed in claim 1, wherein there is a coupling element, which is secured on a housing of the check valve, wherein the coupling element has through openings, which form the outlet channels.

14. The check valve as claimed in claim 13, wherein the piston is guided in the valve body and is arranged at a distance from the coupling element.

15. The check valve as claimed in claim 13, wherein there is a return spring, which presses the piston into a sealing seat in order to close the check valve and wherein the return spring is arranged with a first end in the piston and with a second end in the coupling element.

16. The check valve as claimed in claim 12, wherein the return spring is arranged in the piston and wherein it is surrounded by the outlet channels.

17. The check valve as claimed in claim 13, wherein the check valve has a valve body, wherein the piston is arranged movably in the valve body and wherein the piston is movable with guidance by the valve body and wherein the valve body is the housing.

18. The check valve as claimed in claim 1, wherein there is the same number of outlet channels and surfaces between the ribs.

19. A unit of a hydrogen refueling system comprising a first line for connecting a first storage bank to a dispensing line and comprising a second line for connecting a second storage bank to the same dispensing line,
wherein a fueling direction leads from the first storage bank and the second storage bank to the dispensing line,
wherein a first high-pressure valve and a first check valve are arranged in the first line, wherein the first check valve is arranged after the first high-pressure valve in the fueling direction,
wherein a second high-pressure valve and a second check valve are arranged in the second line, wherein the second check valve is arranged after the second high-pressure valve in the fueling direction,
wherein the first check valve and the second check valve are check valves as claimed in claim 1.

20. The check valve as claimed in claim 6, wherein the outer surface along which the fluid flows is arranged between the ribs.

21. The check valve as claimed in claim 10, wherein at least one part of the piston is manufactured from PEEK.

22. The check valve as claimed in claim 21, wherein the entire piston is manufactured from PEEK.

23. The check valve as claimed in claim 1, wherein the check valve is a check valve of a hydrogen refueling system.
